(19) United States
(12) Patent Application Publication
(10) Pub. No.: US 2002/0111852 A1
(43) Pub. Date: Aug. 15, 2002

(54) Business offering content delivery

(76) Inventor: Robyn R. Levine, Chicago, IL (US)

Correspondence Address: John R. Pivnichny, IBM Corporation, N50/040-4, 1701 North Street, Endicott, NY, 13760, US

(21) Appl. No.: 09/761,121

(22) Filed: Jan. 16, 2001

(51) Int. Cl. G06F 17/60

(52) U.S. Cl. 705/14

(57) ABSTRACT

A method and system for optimizing content delivery to a particular user in response to in the moment point of contact determination, retrieved profiled past, and retrieved current actions. Personalized content comprising a web page, opportunity or take action opportunity is delivered to the user.

### TECHNICAL FIELD

The invention relates generally to methods and structure for optimizing the value of information presented to a customer through a marketing, transactional, informational, or outreach channel. More particularly the invention relates to personalizing the product or service content presented to a customer in order to increase the likelihood of completing a purchase or forming a positive experience.

### BACKGROUND OF THE INVENTION

Processes for conducting commerce whether electronically or by using more traditional means or some combination of the two allow customers and suppliers to engage in business practices using well-known business processes. Technology advances have been applied to both electronic and traditional commerce resulting in improved business efficiency through faster communication methods, paperwork reduction, electronic funds transfers, and improved product and service displays. Both customers and suppliers have benefited from these business process improvements.

One such process improvement involves customizing, individualizing, or personalizing the display of products or services and the content, opportunity, offering, and interactive experience presented to each customer who interacts with a supplier. The benefits of personalization may be to facilitate access by customers to appropriate information and opportunities thereby leading to improved customer satisfaction and repeat purchases in the future. For example, S. Kuhn describes in an article “Affinity Architecture: towards a model for planning and designing comprehensively personalized web applications” published in Journal AGSI (UK) vol.8, no.2, July 1999, p.60-63, a personalized web site architecture having dynamic structure and a rules based content. Personalization is based on a customer's answers to specific questions, observed customer behavior i.e clickstream data, and allowing the customer to select links or categories and place them in a prominent position. Customers may also post their own content for consumption by other customers.

Angles et al. in U.S. Pat. No. 5,933,811 describe delivering customized advertisements within interactive communication systems. When a consumer accesses an offering, an advertising computer generates a custom advertisement based on the consumer's profile. The customized advertisement is combined with the offering and displayed to the consumer. The consumer's profile is stored on the advertising computer and includes the consumer's demographic profile which is provided at the time the consumer first registers with the advertising provider his desire to receive customized advertisements. Demographic data in the profile may include but is not limited to age, sex, income, career, interests, hobbies, and consumer preferences.

In operation, for example, one version of an advertisement can be directed to selling fruit juice to children. Other versions can be directed to selling the same fruit juice to teenagers, adults, or other demographic groups.

LeMole et al. in U.S. Pat. No. 6,009,410 describe another method and system for presenting customized advertising to a user over the World Wide Web. In this system a composite advertising page is dynamically configured for a particular user when that user accesses his or her customized advertising repository (CAR). The page is configured based on a previously provided user profile and on a context dependent basis determined from at least one web site the user has accessed prior to accessing the (CAR). For example the composite advertising page can be based on key words or subject matter content associated with the previously accessed web site.

Gilmour et al. in U.S. Pat. No. 6,115,709 describe a method and system for constructing a user knowledge profile. An electronic document associated with the user may have content indicative of a knowledge base of the user. A confidence level is assigned to the content. The content is then stored in either a public or private portion of the user knowledge profile based on the confidence level.

Thomas et al. in U.S. Pat. No. 6,128,663 describe a method of customizing information presented to a user over a network. Demographic information provided by the user is stored on the user computer. When the user requests a page from a server computer, the server retrieves the stored demographic information. The server computer then customizes a web page based on the request and the demographic information, and transmits the customized web page to the user's computer for display. The interests, preferences, or other types of demographic information may be provided to the various web sites visited, with privacy because the user controls what demographic information is stored and may choose not to include personal information such as name, address, or telephone number.

Despite the systems and methods described above, there remains a great need to more effectively target the information content presented to individual consumers or users to increase the likelihood of purchase of the goods or services presented. A streamlined method of handling the inherent complexities of providing individualized, targeted content and opportunities would therefore be a beneficial improvement. In particular a system and method which determines an improved view of the individual user at the actual point in time and location and devices in use, while relating this view to other profile and current action data to provide take action opportunities would constitute a significant advancement in the art of content delivery.

### OBJECTS AND SUMMARY OF THE INVENTION

It is therefore a principal object of the present invention to enhance the content delivery art by providing a method of presenting offerings and opportunities with enhanced capabilities.

It is another object to provide such a method wherein enhanced offering and opportunity capabilities are possible.

It is a further object to provide a system for personalizing a web site to a user, having enhanced operational capabilities.

It is yet another object to provide a server having enhanced web site personalization capabilities.

These and other objects are attained in accordance with one embodiment of the invention wherein there is provided a method of personalizing content delivery to a user, the method comprising the steps of, determining in the moment point of contact constraints of the user, retrieving a profiled past of the user, retrieving current actions, and delivering content to the user in response to the constraints of the point of contact, the profiled past and the current actions.

In accordance with another embodiment of the invention there is provided a system for personalizing content delivery to a user, comprising, means for determining a point of contact device of the user, means for retrieving a profiled past of the user, means for retrieving current actions, and means for delivering content to the user in response to the point of contact device and the profiled past and the current actions.

### BRIEF DESCRIPTION OF THE DRAWINGS

FIG. 1 is a diagram of a method and system for personalizing content;

FIG. 2 shows stacking profiles of a user; and

FIG. 3 shows one embodiment for delivering content in accordance with the present invention.

### BEST MODE FOR CARRYING OUT THE INVENTION

For a better understanding of the present invention, together with other and further objects, advantages, and capabilities thereof, reference is made to the following disclosure and the appended claims in connection with the above-described drawings.

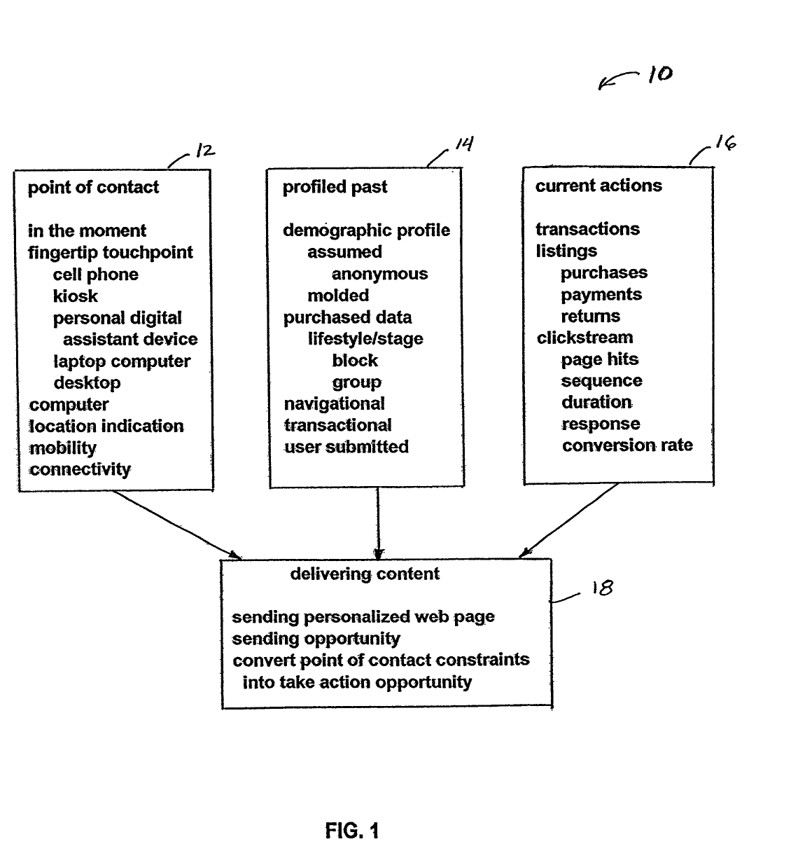

In FIG. 1 there is shown a chart 10 of a method and system for personalizing content in accordance with the present invention. The method and system relate to attempts by a merchant to present his products or services to a user or potential customer in the most favorable manner and thereby maximize the resulting purchases. Likewise the user wishes to interact with the merchant, for example over an e-commerce network, in the most pleasant and enjoyable manner to achieve whatever shopping objectives the user may have at that point in time, space, connectivity, mobility or other constraints under which the user is operating. The result is therefore beneficial to both the merchant and user.

The merchant has a capability for interacting with the user. This capability may be a web site accessed as a unique URL (uniform resource location) address on the World Wide Web. Other equivalent e-commerce web site access methods may also be used as well as any other networked connectivity or conventional interaction including but not limited to telephone, terminal, cell phone or print media.

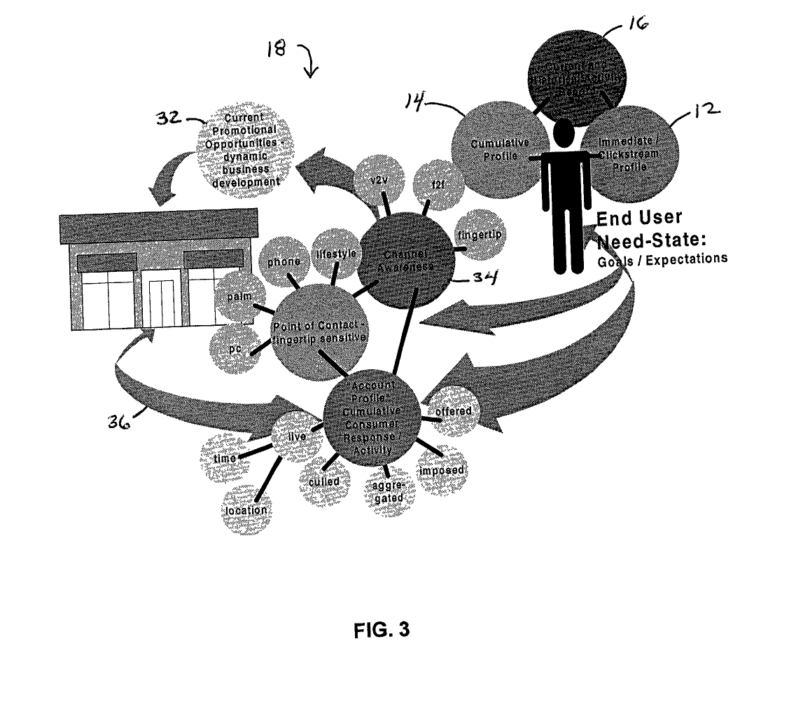

In one method embodiment of the present invention, in step 12 of FIG. 1, in the moment point of contact constraints, also called in FIG. 3 an immediate/clickstream profile, of the user are determined. The user is interacting with the supplier using some type of device which may be a cell phone, kiosk, personal digital assistant such as a palm top device, a laptop computer, a desktop computer, a computer terminal or any other access device. The type of device is determined using techniques such as interrogation commands, cookies, or any other known or equivalent technique. From the type of device other constraints may be determined such as display size, resolution, refresh rate, color capability, keyboard entry capability, other entry capability such as pointer or mouse, speech recognition and response, language constraints, and any other fingertip touchpoint constraints and assumptions about user state. For example someone using a cellular phone has a limited time window and is sensitive to location and local time of day, whereas a casual home browser may have a greater luxury of time and faster connectivity.

The term, in the moment point of contact, shall be taken to mean at the time and place the user makes access. Both time and location may be of sufficient precision for the needs of the content to be provided. For example, products having a high time or location value such as a provided by a dinner-theater restaurant might need to know how close the user is located to the restaurant, and how much time the user has to get there. Likewise the time and/or location of a mobile user might need to be determined on a more frequent basis while the same information for a home user at a desktop computer might need to be determined only once e.g. at the start of an access session. Other constraints as described in this specification shall also be included in the meaning of the term.

A location indication of the point of contact may also be determined in step 12. For example, GPS (geological positioning system) coordinates of the user may be determined if the user device has such a capability whether by including a real time GPS receiver or by periodically storing GPS coordinates entered by some other method. Other location indications may also be determined such as post office address, street or crossroad coordinates, latitude-longitude coordinates or any other location indicating system. Determining a location is advantageous in the case of a user having a portable device and particularly advantageous when the user is mobile when in actual motion or temporarily stopped.

The connectivity may also be determined. For example the user may be connected to the supplier in any of a number ways such as a modem, digital modem, network, or high speed lines including fiber optic lines. The connection may also be wireless whether by a terrestrial or satellite radio link or by an infrared or other circuit. Each way of connection imposes constraints of speed, latency, mobility which can then also be determined.

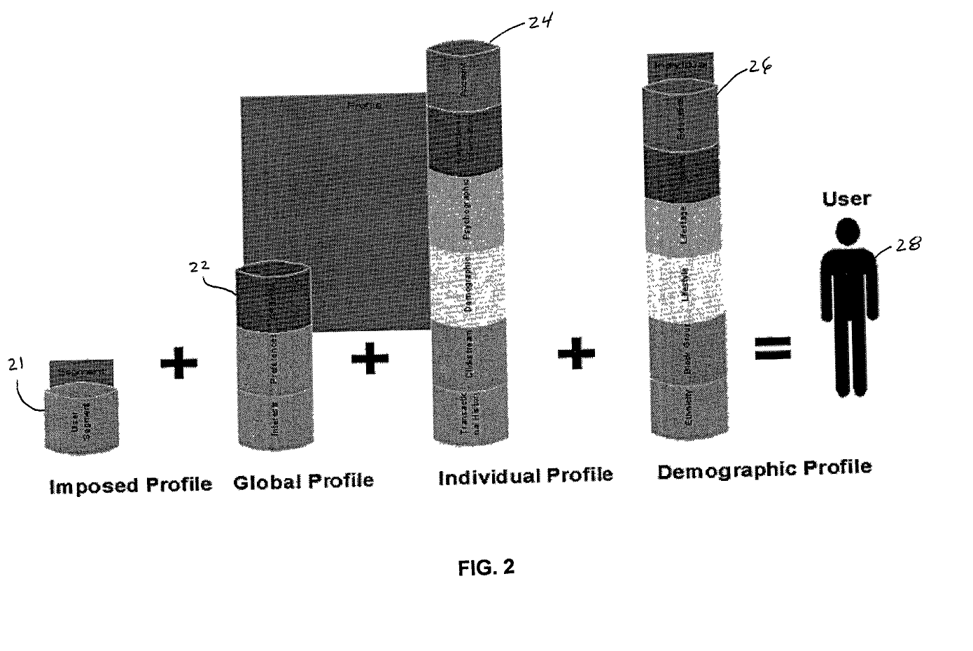

In step 14 of FIG. 1 a profiled past, also called a cumulative profile in FIG. 3, of the user is retrieved. The profiled past comprises data for individualization of the content and drives opportunity delivery as explained below. This data may be retrieved from a file, database, data warehouse or any other data storage device. Multiple storage devices and software may be used. Some or all of the data may be retrieved from the point of contact device in use. The profiled past may comprise an imposed profile 21, global profile 22, individual profile 24, and demographic profile 26 as shown in FIG. 2. The profiles of FIG. 2 may be combined or layered to define the user 28 for specific promotions.

For example, the demographic profile of the user may include ethnicity, block group, lifestyle, lifestage, income, and education data. This entire demographic profile 26 can become a layer of the individual profile 24 which comprises transactional history data, certain clickstream data, the demographic file, psychographic, registration e.g. customer provided data, and account data. Psychographic data is taken herein to mean an attitude profile of the user. Examples of attitude profiles include a trend buyer, or a time-strapped person who prefers to purchase a complete outfit, or a professional buyer who prefers to mix and match individual items from various suppliers.

FIG. 2 also shows a global profile 22 comprising data on the user interests, preferences, and affiliation. An imposed profile 21 provided by the merchant, for example, a time-strapped profile directed to the too busy to shop person above who wants to purchase an entire outfit as quickly as possible, or a profile directed to a customer desiring to express self by buying perhaps one item of an outfit at one e-business store and other items at other stores, could be profiles imposed by the particular merchant.

The profiled past of step 14 may also comprise retrieving purchased data whether or not a part of the demographic profile 26 or any other profile. Various firms provide data for purchase which is grouped or keyed to presenting a lifestyle or lifestage view of users by block or group or some baseline parameter. The purchased data presents a view of the user based on aggregation of data points such as, but not limited to geographic block, age of head of household, income level, number of children, education, ethnicity, and buying patterns.

The profiled past 14 may also include navigational data relating to the path the user used to arrive at a web page which indicates where the user came from. Transactional data of actions taken, was the transaction a first time or repeat action, and how much the user usually spends may also be included in the profiled past 14. Data voluntarily submitted by the user in responding to questions is also included.

In step 16 of FIG. 1, current actions, also called a current and historical record in FIG. 3, are retrieved. Current actions are data defining user behavior. One source of current actions is listings of the purchases made by the user. Listings of payments and returns made by the user may also be included in current actions.

Another source of current actions is clickstream data from a point of contact device of the user. Clickstream data may include page hits, sequence of hits, duration of page views, response to advertisements, transactions made, and conversion rates. Conversion rate is the number of times the user takes action divided by the number of times an opportunity is presented.

In step 18, content is delivered to the user. The content is formed in response to the in the moment point of contact constraints of step 12 and the profiled past of step 14, and the current actions of step 16. Many additional factors such as current business goals or session specific intent may also be included in forming the content in step 18 without departing from the scope of the invention.

Delivering content may comprise sending content formed in step 18 to the user. Delivering content may also comprise sending an opportunity, which may be in the form of a web page, formed in step 18. The opportunity may be a take action opportunity such as asking the user to make an immediate purchase, select a particular item, request a download or other action.

Delivering content may also comprise pushing advertisements and opportunities to effectively and appropriately drive the point of contact user to some conclusion or reaction desired by the merchant. The advertisements and opportunities are formed in a dynamic closed loop manner in which the content delivery depends on the point of contact 12, profiled past 14, and current actions 16 of FIG. 1 as well as sensing and analyzing a user response to a previous advertisement or opportunity just delivered. All interchanges with the user may therefore collect and sense user behavior which is then included in the profiled past 14 or current actions 16 data.

In one embodiment of the invention as shown in FIG. 3, content is delivered by creating a vision of the supplier's core competencies based on the user-centered perspective of point of contact 12, profiled past 14, and current actions 16. Current promotional opportunities 32 are developed consistent with the vision by merging together and optimizing this user centered perspective with the supplier's channel awareness whether voice-to-voice, V2V, or face-to-face, F2F, or fingertip device. Closed loop content delivery as explained above is possible by sensing and feeding back, via path 36, user response or actions to previous content delivery.

While there have been shown and described what are at present considered the preferred embodiments of the invention, it will be obvious to those skilled in the art that various changes and modifications may be made therein without departing from the scope of the invention as defined by the appended claims.

What is claimed is:

1. A method of personalizing content delivery to a user, said method comprising the steps of:
determining in the moment point of contact constraints of said user;
retrieving a profiled past of said user;
retrieving current actions; and
delivering content to said user in response to said constraints of said point of contact, said profiled past and said current actions.

2. The method of claim 1, wherein said step of determining in the moment point of contact comprises the step of determining constraints of a current fingertip touchpoint of said user.

3. The method of claim 2, wherein said touchpoint comprises a cell phone, kiosk, personal digital assistant device, laptop computer, terminal, or desktop computer.

4. The method of claim 1, wherein said point of contact constraints includes a location indication.

5. The method of claim 4, wherein said location indication includes global positioning system coordinates.

6. The method of claim 1, wherein said profiled past includes a demographic profile.

7. The method of claim 6, wherein said demographic profile is assumed.

8. The method of claim 7, wherein said demographic profile is assumed based on anonymous demographic data supplied by a third party.

9. The method of claim 6, wherein said demographic profile is layered.

10. The method of claim 1, wherein said profiled past includes purchased data.

11. The method of claim 10, wherein said purchased data is lifestyle or lifestage views of users based on a baseline parameter.

12. The method of claim 11, wherein said baseline parameter is a block or group.

13. The method of claim 1, wherein said profiled past includes data generated by datamining of navigational and transactional information, or user submitted data, or purchased data, or combinations thereof.

14. The method of claim 1, wherein said current actions includes transactions.

15. The method of claim 14, wherein said transactions includes listings of purchases or payments or returns.

16. The method of claim 1, wherein said current actions includes clickstream data.

17. The method of claim 16, wherein said clickstream data includes page hits, sequence of hits, duration of page views, response to advertisements, transactions, or conversion rates.

18. The method of claim 1, wherein the step of said delivering said content comprises the step of sending a personalized web page to said user.

19. The method of claim 1, wherein said content is an opportunity.

20. The method of claim 1, wherein said content is delivered by converting said point of contact constraints into a take action opportunity.

21. A system for personalizing content delivered to a user, comprising:
means for determining a point of contact device of said user;
means for retrieving a profiled past of said user;
means for retrieving current actions; and
means for delivering content to said user in response to said point of contact device and said profiled past and said current actions.

22. A server having a web site for providing personalized content to a user, comprising:
a computer processor having server software installed for processing a web site having content;
means for determining a point of contact device of said user;
means for retrieving a profiled past of said user;
means for retrieving current actions; and
wherein said server software is adapted for delivering said web site content personalized to said user in response to said point of contact device and said profiled past and said current actions.

23. A computer program product for instructing a processor to provide a web site accessible by a user having a point of contact device, said computer program product comprising:
means for determining said point of contact device of said user;
means for retrieving a profiled past of said user;
means for retrieving current actions; and
wherein said computer program product is adapted for delivering web site content personalized to said user in response to said point of contact device and said profiled past and said current actions.
